(19) United States
(12) Patent Application Publication
(10) Pub. No.: US 2018/0086153 A1
(43) Pub. Date: Mar. 29, 2018

(54) PNEUMATIC TIRE

(71) Applicant: TOYO TIRE & RUBBER CO., LTD., Osaka (JP)

(72) Inventor: Kouichi Takita, Osaka-shi (JP)

(73) Assignee: TOYO TIRE & RUBBER CO., LTD., Osaka (JP)

(21) Appl. No.: 15/492,067

(22) Filed: Apr. 20, 2017

(30) Foreign Application Priority Data
Sep. 27, 2016 (JP) 2016-188096

(51) Int. Cl. B60C 13/02; B60C 11/01

(52) U.S. Cl. CPC B60C 13/02; B60C 11/01

(57) ABSTRACT

A pneumatic tire has a pair of bead portions, side wall portions and a tread portion. An annular projections group in which plural kinds of projections having different volumes are arranged in a tire circumferential direction is formed on an outer surface of a buttress region of the side wall portion. On the assumption that a first projection is constructed by a projection having the smallest volume, and a second projection is constructed by a projection having the largest volume in the projections included in the annular projections group, a ratio V2/V1 goes beyond 1.00 and is less than 5.00, the ratio V2/V1 being a ratio of a volume V2 of the second projection in relation to a volume V1 of the first projection.

### BACKGROUND OF THE INVENTION

### Field of the Invention

The present invention relates to a pneumatic tire aiming at traveling on a punishing road such as a muddy terrain and a rocky stretch.

### Description of the Related Art

With regard to the pneumatic tire aiming at the traveling on the punishing road, there has been known a technique in which an annular projections group having a plurality of projections arranged in a tire circumferential direction is formed on an outer surface of a buttress region of a side wall portion. For example, Patent Documents 1 to 3 filed by the applicant of the present application should be referred. According to the configuration mentioned above, in a scene traveling on a muddy terrain and a sand pip, traction is generated by shear resistance of the projections and it is possible to improve a punishing road traveling property.

The Patent Document 1 discloses an example in which a plurality of projections included in an annular projections group are uniformly provided and sizes of the projections are fixed. Meanwhile, in recent years, there has been proposed a structure in which projections having different magnitudes and shapes are arranged, for improving a catching action in the rocky stretch and enhancing a design property by applying a stereoscopic effect to the buttress region.

However, in the case that the annular projections group is formed by plural kinds of projections having different volumes, a fluctuation in a thickness of the buttress region is enlarged along the tire circumferential direction. As a result, there is generated a portion where the rubber does not sufficiently circulate around at the curing time, and there is a case that a rubber defect called as a bare is generated in the projections of the molded tire. Further, dynamic unbalance of the tire tends to be deteriorated on the basis of the enlargement in the fluctuation of the thickness in the buttress region.

### PRIOR ART DOCUMENT

### Patent Document

Patent Document 1: JP-A-2004-291936

Patent Document 2: JP-A-2010-264962

Patent Document 3: JP-A-2013-119277

### SUMMARY OF THE INVENTION

The present invention is made by taking the above actual condition into consideration, and an object of the present invention is to provide a pneumatic tire which can suppress generation of a bare and reduce dynamic unbalance while forming an annular projections group in which plural kinds of projections having different volumes are arranged.

The object can be achieved by the following present invention. The present invention provides a pneumatic tire comprising a pair of bead portions, side wall portions which extend outward in a tire diametrical direction from each of the bead portions, and a tread portion which is connected to an outside end in the tire diametrical direction of each of the side wall portions, wherein an annular projections group in which plural kinds of projections having different volumes are arranged in a tire circumferential direction is formed on an outer surface of a buttress region of the side wall portion, wherein on the assumption that a first projection is constructed by a projection having the smallest volume, and a second projection is constructed by a projection having the largest volume in the projections included in the annular projections group, a ratio V2/V1 goes beyond 1.00 and is less than 5.00, the ratio V2/V1 being a ratio of a volume V2 of the second projection in relation to a volume V1 of the first projection.

In the tire, since the annular projections group as mentioned above is formed in the buttress region, and the ratio V2/V1 goes beyond 1.00, there can be obtained an effect of improving the catching action in the rocky stretch and enhancing the design property by applying the stereoscopic effect to the buttress region. Further, since the ratio V2/V1 is less than 5.00, the fluctuation in the thickness of the buttress region does not become too large along the tire circumferential direction. As a result, it is possible to reduce the dynamic unbalance as well as suppressing the generation of the bare.

In order to securely obtain the effect of improving the catching action in the rocky stretch and enhancing the design property by applying the stereoscopic effect to the buttress region, the ratio V2/V1 is preferably equal to or more than 2.00. Further, in order to make the fluctuation in the thickness of the buttress region caused by the annular projections group smaller, the ratio V2/V1 is preferably less than 4.00.

It is preferable that a circumferential rib extending in the tire circumferential direction and connecting the projections each other is formed on the outer surface of the buttress region in the side wall portion. The rigidity of each of the projections is enhanced by the connection with the circumferential rib, and it is possible to improve the traction caused by the shear resistance of the projections.

The ratio V2/V1 in the annular projections group which is formed in one side in the tire width direction may be smaller than the ratio V2/V1 in the annular projections group which is formed in the other side. In that case, it is preferable that a void ratio of a ground surface in one side in the tire width direction is larger than a void ratio of the ground surface in the other side, on the basis of a tire equator. As a result, it is possible to cancel the lateral unbalance in the tread portion by the annular projections group, and it is possible to obtain the effect of suppressing the deterioration of the dynamic unbalance.

### BRIEF DESCRIPTION OF THE DRAWINGS

FIG. 1 is a tire meridian half cross sectional view schematically showing an example of a pneumatic tire according to the present invention;

FIG. 2 is a side elevational view showing a part of a buttress region of the tire as seen from a tire width direction; and

FIG. 3 is an enlarged view of a substantial part in FIG. 1.

### DETAILED DESCRIPTION OF THE PREFERRED EMBODIMENTS

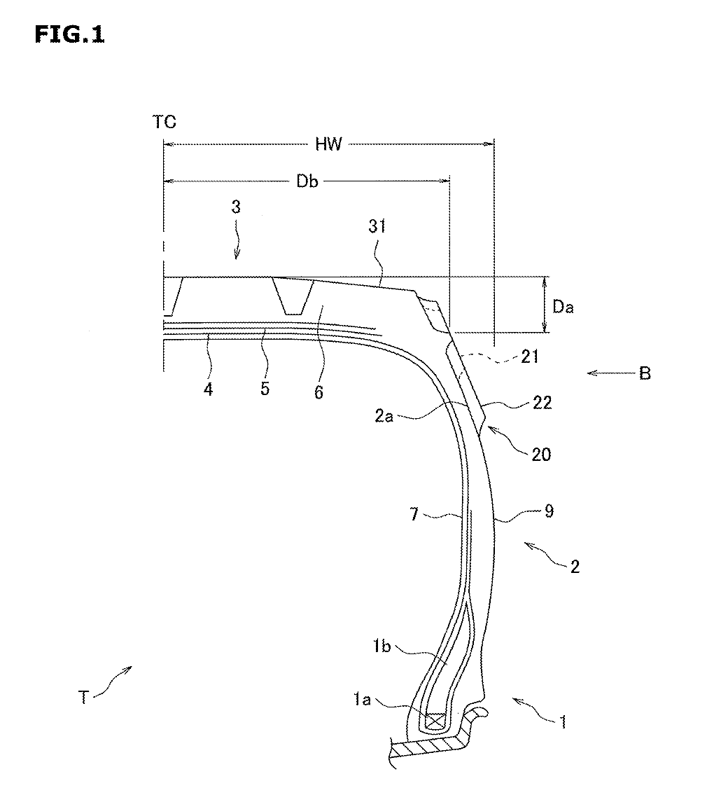

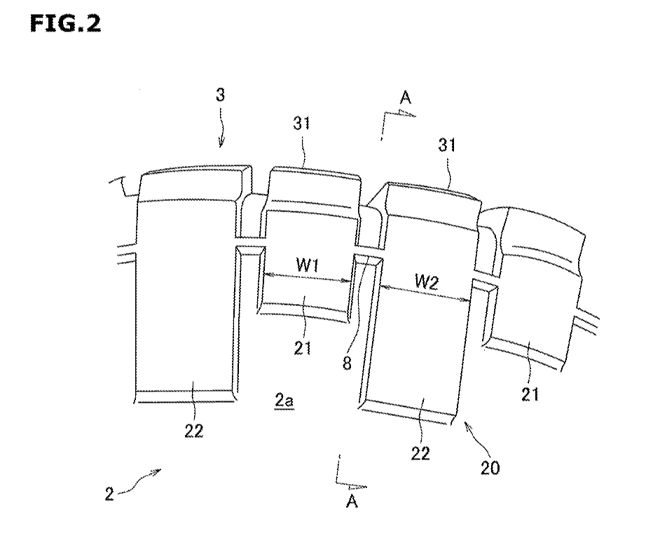

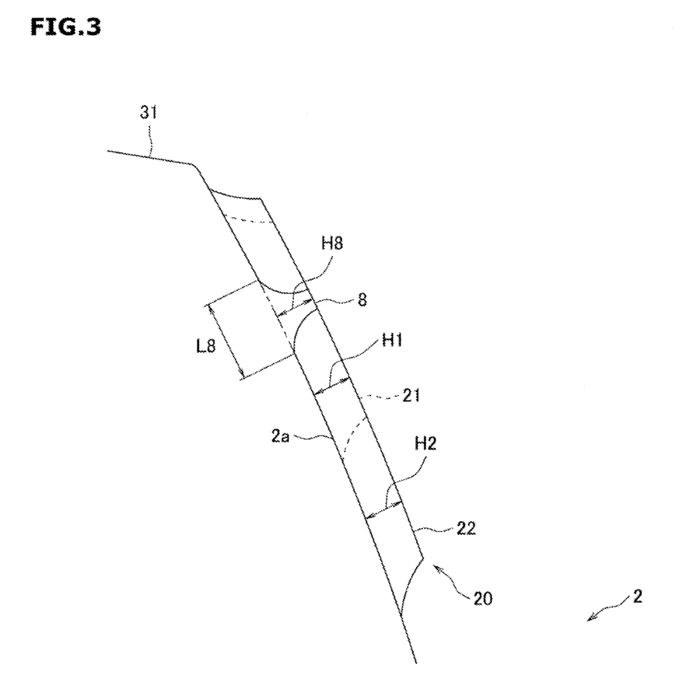

An embodiment of the present invention will be explained with reference to the drawings. FIG. 1 is a tire meridian half cross sectional view schematically showing an example of a pneumatic tire according to the present invention, and corresponds to a cross sectional view along a line A-A in FIG. 2. FIG. 2 is a side elevational view showing a part of a buttress region as seen from a tire width direction, and corresponds to a view as seen from an arrow B in FIG. 1. FIG. 3 is an enlarged view of a substantial part in FIG. 1.

A pneumatic tire T is an off-road pneumatic radial tire aiming at traveling on a punishing road which includes a muddy terrain and a rocky stretch. The tire T is provided with a pair of bead portions 1, side wall portions 2 which extend outward in a tire diametrical direction from each of the bead portions 1, and a tread portion 3 which is connected to an outside end in the tire diametrical direction of each of the side wall portions 2. The bead portion 1 is provided with an annular bead core 1a formed by coating a convergence body of steel wire with rubber, and a bead filler 1b which is arranged in an outer side in the tire diametrical direction of the bead core 1a.

The pneumatic tire T is further provided with a carcass 4 which is arranged between a pair of bead portions 1, and a belt 5 which is arranged in an outer peripheral side of the carcass 4 in the tread portion 3. The carcass 4 is formed into a toroidal shape as a whole, and is wound up its end portion in such a manner as to pinch the bead core 1a and the bead filler 1b. The belt 5 includes two belt plies which are layered inward and outward, and is provided with a tread rubber 6 in its outer peripheral side. A tread pattern is formed on a surface of the tread rubber 6.

An inner liner 7 is provided in an inner peripheral side of the carcass 4 for keeping pneumatic pressure. The inner liner 7 faces to an internal space of the tire T in which air is filled. In the side wall portion 2, the inner liner 7 is directly attached to an inner peripheral side of the carcass 4, and any other member is not interposed between them.

As shown in FIGS. 2 and 3, an annular projections group 20 in which plural kinds (two kinds in the present embodiment) of projections 21 and 22 having different volumes are arranged in a tire circumferential direction is formed on an outer surface 2a of a buttress region of the side wall portion 2. The buttress region is a region in an outer side in a tire diametrical direction of the side wall portion 2, and more particularly a region in the outer side in the tire diametrical direction from a tire maximum width position 9, and corresponds to a region which does not ground contact at the normal traveling time on a flat paved road. Since the tire sinks down on a soft road such as the muddy terrain and the sand pip due to a weight of a vehicle, the buttress region ground contacts in a pseudo manner.

In the present embodiment, there is shown an example in which two kinds of projections 21 and 22 having different volumes are alternately arranged. A width of a gap existing between the adjacent projections 21 and 22 is set to be smaller than a width of each of the projections 21 and 22 in both sides of the gap. The projection 21 and the projection 22 are alternately arranged in the same manner in the other portions which are not shown, and an arrangement body thereof constructs an annular projections group 20. The projections constructing the annular projections group are not limited to two kinds, but the annular projections group may be formed by arranging three or more kinds (for example, three to ten kinds) of projections having different volumes.

Each of the projections 21 and 22 constructing the annular projections group 20 bulges from the outer surface 2a of the side wall portion 2 along a profile line of the tire T, and the volume of each of the projections 21 and 22 is determined on the basis of the portion bulging from the outer surface 2a. In the present embodiment, there is shown an example in which a circumferential rib 8 is formed in the buttress region as mentioned later, however, a portion of the circumferential rib 8 protruding out of a side surface of each of the projections 21 and 22 is not considered as the volume of the projections 21 and 22 in this case.

The volume of the projection can be determined, for example, by measuring concavities and convexities of the side wall portion with using a three-dimensional measuring tool and preparing a three-dimensional modeling while combining actually measured dimensional values as occasion demands. Alternatively, it can be determined by molding the side wall portion with using gypsum and utilizing the gypsum mold.

In this tire T, on the assumption that a first projection is constructed by a projection having the smallest volume (the projection 21 in the present embodiment), and a second projection is constructed by a projection having the largest volume (the projection 22 in the present embodiment) in the projections included in the annular projections group 20, a ratio V2/V1 goes beyond 1.00 and is less than 5.00, the ratio V2/V1 being a ratio of a volume V2 of the second projection (that is, the projection 22) in relation to a volume V1 of the first projection (that is, the projection 21).

Since the ratio V2/V1 goes beyond 1.00, there can be obtained an effect of improving the catching action on the rocky stretch and enhancing design property by applying the stereoscopic effect to the buttress region. In order to securely obtain the effect, the ratio V2/V1 is preferably equal to or more than 2.00. Further, since the ratio V2/V1 is less than 5.00, the fluctuation in the thickness of the buttress region does not become great too much along the tire circumferential direction. As a result, it is possible to reduce the dynamic unbalance as well as suppressing the generation of the bare. In order to make the fluctuation in the thickness of the buttress region caused by the annular projections group 20, the ratio V2/V1 is preferably less than 4.00.

As shown in FIG. 2, each of the projections 21 and 22 is formed into a rectangular shape in a side view, however, may be formed into the other polygonal shapes than the rectangular shape or the other shapes without being limited to this. In the present embodiment, each of the projections 21 and 22 extends in the tire diametrical direction, and a tire diametrical outside end (hereinafter, referred to as an outside end) thereof is connected to a side surface of a land portion 31 in the tread portion 3. Further, a tire diametrical inside end (hereinafter, referred to as an inside end) is arranged in an outer side in the tire diametrical direction than the tire maximum width position 9.

The tire maximum width position 9 is a position where a profile line of the tier T is away from a tire equator TC at the maximum in the tire width direction. The profile line is a contour line which forms an outer surface of the side wall portion 2 except the projections, and normally has a meridian cross sectional shape which is defined by smoothly connecting a plurality of circular arcs.

The projections 21 and 22 according to the present embodiment are differentiated from each other in their lengths in the tire diametrical direction, however, widths W1 and W2 in the tire circumferential direction are set to be approximately the same dimension, and heights H1 and H2 from the outer surface 2a are set to be approximately the same dimension. In order to enhance the effects of improving the catching action on the rocky stretch and improving the design property by applying the stereoscopic effect to the buttress region, the first projection and the second projection are preferably differentiated from each other in at least one of the length and the height.

As shown in FIG. 3, the heights H1 and H2 of the projections 21 and 22 are approximately fixed from an edge of the outside end to an edge of the inside end. The greater the heights H1 and H2 are, the more the punishing road traveling property can be improved by enhancing the traction caused by the shear resistance, and the more the external damage resistance can be improved by keeping the external damage factor such as an angular portion of a rock face away from the outer surface 2a. In the light of the above, each of the height H1 and the height H2 is preferably equal to or more than 5 mm, and more preferably equal to or more than 8 mm.

In the present embodiment, a circumferential rib 8 extending in the tire circumferential direction and connecting the projections each other is formed on the outer surface 2a in the buttress region of the side wall portion 2. The rigidity of each of the projections 21 and 22 is enhanced by the connection with the circumferential rib 8, and it is possible to improve the traction caused by the shear resistance of the projection. The circumferential rib 8 extends on an annular line which is along the tire circumferential direction. Each of the projections 21 and 22 extends to an inner side and an outer side in the tire diametrical direction from the circumferential rib 8, however, preferably extends at least to the inner side in the tire diametrical direction from the circumferential rib 8.

A cross sectional shape of the circumferential rib 8 is formed into a flat chevron shape in its upper end surface, and more particularly formed into a composite volcano shape that an inclined surface is gently curved and narrowed. In the light of enhancement in the rigidity of the projection, a height H8 of the circumferential rib 8 is preferably equal to or more than 5 mm, more preferably goes beyond 5 mm, and is further preferably equal to or more than 8 mm. In the present embodiment, the height of the circumferential rib 8 is substantially the same as the height of each of the projections 21 and 22, however, is not limited to this. Further, in the light of enhancement in the rigidity of the projection, a contact length L8 of the circumferential rib 8 in relation to the outer surface 2a is preferably equal to or more than the height H8.

The circumferential rib 8 is set, for example, to a position where a distance Da shown in FIG. 1 is in a range between 20 and 40 mm. The distance Da is determined as a distance in the tire diametrical direction from a position of the outermost diameter of the tire T to a tire diametrical outside edge of an upper end surface of the circumferential rib 8. Further, the circumferential rib 8 is set, for example, to a position where a distance Db shown in FIG. 1 is 75% or more of a tire cross section half width HW. The distance Db is determined as a distance in the tire width direction from the tire equator TC to the tire diametrical outside edge of the upper end surface of the circumferential rib 8, and the tire cross section half width HW is determined as a distance in the tire width direction from the tire equator TC to the tire maximum width position 9.

The annular projections group 20 may be formed in the side wall portion 2 at least in one side, however, in order to improve the punishing road traveling property and the external damage resistance, it is preferably formed in the side wall portions 2 in both sides. In the case that the annular projections group 20 is formed in the side wall portions 2 in both sides, the ratio V2/V1 may be the same, or may be different from each other. More specifically, the ratio V2/V1 in the annular projections group 20 formed in one side in the tire width direction may be smaller than the ratio V2/V1 in the annular projections group 20 formed in the other side.

In the case that the ratio V2/V1 in the annular projections group 20 formed in one side in the tire width direction is smaller than the ratio V2/V1 in the annular projections group 20 formed in the other side, a void ratio of the ground surface in one side in the tire width direction is preferably larger than a void ratio of the ground surface in the other side on the basis of the tire equator TC. As a result, it is possible to cancel lateral unbalance of the tread portion by the annular projections group, and there can be obtained an effect of suppressing deterioration of the dynamic unbalance.

The void ratio is calculated as a ratio of a surface area in a groove region in relation to a surface area in a ground contact region of the tread portion 3, and sipes having the width which is less than 1.5 mm are not included in the groove. A tread pattern in which the void ratio is different between one side and the other side in the tire width direction as mentioned above is asymmetric in relation to the tire equator TC. In this case, the region having the relatively smaller void ratio is preferably set to the inner side of the vehicle, and the region having the relatively larger void ratio is preferably set to the outer side of the vehicle. As a result, it is possible to suppress the irregular wear in the vehicle inside region of the tread portion 3 in the vehicle in which an camber angle is set in a negative direction.

The tire having the asymmetric pattern is normally designated its direction to be installed to the vehicle, and more specifically designated which of the right and left sides of the tire is faced to the vehicle. Such designation is achieved, for example, by providing a display indicating a vehicle inside or a vehicle outside to the side wall portion of the tire.

Each of the dimensional values mentioned above is measured in a no-load normal state in which the tire is installed to a normal rim and a normal internal pressure is filled in the tire. The normal rim is a rim which is defined by a standard for every tire in a standard system including the standard on which the tire is based, for example, a standard rim in JATMA, “Design Rim” in TRA or “Measuring Rim” in ETRTO. Further, the normal internal pressure is a pneumatic pressure which is defined by each of the standards for every tire in the standard system including the standard on which the tire is based, and is a maximum pneumatic pressure in JATMA, the maximum value described in Table “TIRE LOAD LIMITS AT VARIOUS COLD INFLATION PRESSURES” in TRA, or “INFLATION PRESSURE” in ETRTO.

Since the pneumatic tire according to the present invention has the annular projections group which can improve the punishing road traveling property, the pneumatic tire can be preferably employed in a light truck such as a pickup truck for an off-road racing aiming at traveling on the punishing road including the muddy terrain and the rocky stretch, and for a vehicle dispatched to a disaster site.

The pneumatic tire according to the present invention can be configured in the same manner as the regular pneumatic tire except the formation of the annular projections group as mentioned above in the buttress region of the side wall portion. Therefore, the conventionally known materials, shapes, structures and manufacturing methods can be employed in the present invention.

The present invention is not limited to the embodiment mentioned above, but can be improved and modified variously within the scope of the present invention.

### Examples

A description will be given below of examples which particularly indicate the configuration and the effect of the present invention. Evaluation of each of performances of the tire was carried out by the following items (1) and (2).

### (1) Bare Generation Circumstance

In a cured tire, “with” was evaluated in the case that a bare was recognized in a projection constructing an annular projections group in a buttress region, and an outer appearance quality thereof deflected from an allowable level. Further, “without” was evaluated in the case that the bare was not recognized and the case that the bare was somewhat recognized and the outer appearance quality was in the allowable level.

### (2) Dynamic Unbalance (DUB)

In the cured tire, dynamic unbalance (DUB) was measured by using a dynamic balance inspection device which was installed in a uniformity measuring line of a tire manufacturing factory. The smaller the numerical value is, the lower and better the dynamic unbalance is.

The pneumatic tires described in the Patent Documents 2 and 3 were set to comparative examples 1 and 2, and the pneumatic tires having the configuration described in the embodiment mentioned above were set to working examples 1 to 3. Further, the pneumatic tire having the same configuration as the comparative example 1 except a point that the projections included in the annular projections group were uniformly provided was set to comparative example 3. In Table 1, the description “plural kinds” means a matter that the annular projections group is formed by plural kinds of projections having different volumes, and the description “one kind” means a matter that the annular projections group is formed by one kind of projections.

TABLE 1

| | Comparative | Comparative | Comparative | Working | Working | Working |
|---|---|---|---|---|---|---|
| | example 1 | example 2 | example 3 | Example 1 | Example 2 | Example 3 |
| Projections | Plural | Plural | One kind | Plural | Plural | Plural |
| | kinds | kinds | | kinds | kinds | kinds |
| V2/V1 | Equal to or | Equal to or | 1.00 | 4.99 | 2.00 | 3.00 |
| | more than | more than | | | | |
| | 5.00 | 5.00 | | | | |
| Generation | With | With | Without | Without | Without | Without |
| of bare | | | | | | |
| DUB | 120 g | 120 g | 80 g | 100 g | 90 g | 95 g |

In the working examples 1 to 3, the generation of bare is suppressed in comparison with the comparative examples 1 and 2, and the dynamic unbalance can be reduced. Further, in the comparative example 3, since a plurality of projections included in the annular projections group are uniformly provided, it is impossible to obtain the effect of improving the catching action on the rocky stretch and enhancing the design property by applying the stereoscopic effect to the buttress region. On the contrary, the working examples 1 to 3 can obtain the above effects since the annular projections group is formed by the plural kinds of projections having different volumes.

What is claimed is:

1. A pneumatic tire comprising:
a pair of bead portions:
side wall portions which extend outward in a tire diametrical direction from each of the bead portions; and
a tread portion which is connected to an outside end in the tire diametrical direction of each of the side wall portions,
wherein an annular projections group in which plural kinds of projections having different volumes are arranged in a tire circumferential direction is formed on an outer surface of a buttress region of the side wall portion,
wherein on the assumption that a first projection is constructed by a projection having the smallest volume, and a second projection is constructed by a projection having the largest volume in the projections included in the annular projections group, a ratio V2/V1 goes beyond 1.00 and is less than 5.00, the ratio V2/V1 being a ratio of a volume V2 of the second projection in relation to a volume V1 of the first projection.

2. The pneumatic tire according to claim 1, wherein the ratio V2/V1 is equal to or more than 2.00.

3. The pneumatic tire according to claim 1, wherein the ratio V2/V1 is less than 4.00.

4. The pneumatic tire according to claim 1, wherein a circumferential rib extending in the tire circumferential direction and connecting the projections each other is formed on the outer surface of the buttress region in the side wall portion.

5. The pneumatic tire according to claim 1, wherein the ratio V2/V1 in the annular projections group which is formed in one side in the tire width direction is smaller than the ratio V2/V1 in the annular projections group which is formed in the other side.

6. The pneumatic tire according to claim 5, wherein a void ratio of a ground surface in one side in the tire width direction is larger than a void ratio of the ground surface in the other side, on the basis of a tire equator.

7. The pneumatic tire according to claim 1, wherein the annular projections group is formed by alternately arranging two kinds of projections having different volumes.

8. The pneumatic tire according to claim 1, wherein the annular projections group is formed by arranging three or more kinds of projections having different volumes.

9. The pneumatic tire according to claim 1, wherein a width of a gap existing between the adjacent projections is set to be smaller than a width of each of the projections existing in both sides of the gap.

10. The pneumatic tire according to claim 1, wherein each of the projections extends in the tire diametrical direction, and a tire diametrical outside end thereof is connected to a side surface of a land portion of the tread portion.

11. The pneumatic tire according to claim 1, wherein each of the projections extends in the tire diametrical direction, and a tire diametrical inside end thereof is arranged in an outer side in the tire diametrical direction than a tire maximum width position.

12. The pneumatic tire according to claim 1, wherein the first projection and the second projection are differentiated from each other in at least one of their lengths and heights.
